(19) United States
(12) Patent Application Publication
(10) Pub. No.: US 2014/0340336 A1
(43) Pub. Date: Nov. 20, 2014

(54) PORTABLE TERMINAL AND METHOD FOR CONTROLLING TOUCH SCREEN AND SYSTEM THEREOF

(71) Applicant: SAMSUNG ELECTRONICS CO., LTD., Gyeonggi-do (KR)

(72) Inventor: Dong-Shin JUNG, Gyeonggi-do (KR)

(73) Assignee: SAMSUNG ELECTRONICS CO., LTD., Gyeonggi-do (KR)

(21) Appl. No.: 14/278,092

(22) Filed: May 15, 2014

(30) Foreign Application Priority Data
May 15, 2013 (KR) 10-2013-0055012

(51) Int. Cl. G06F 3/01

(52) U.S. Cl. CPC G06F 3/017; G06F 2203/04104
USPC 345/173

(57) ABSTRACT

A portable terminal and a method for remotely controlling a touch screen, and a system thereof are provided. The method includes receiving information regarding at least one event; analyzing a type of the event using the received information; and displaying a result corresponding to the event on the touch screen by mapping the analyzed type of event to a physical input value.

### PRIORITY

This application claims priority under 35 U.S.C. §119(a) to Korean Application Serial No. 10-2013-0055012, which was filed in the Korean Intellectual Property Office on May 15, 2013, the entire content of which is incorporated herein by reference.

### BACKGROUND OF THE INVENTION

1. Field of the Invention

The present invention relates generally to a portable terminal, and more particularly, to a portable terminal and a method for controlling a touch screen, and a system thereof.

2. Description of the Related Art

In recent years, various services and additional functions provided by a portable terminal have increased. Diverse applications executable in the portable terminal have been developed in order to enhance an effective value of the portable terminal, and address various needs of users.

Accordingly, several to hundreds of applications can be stored in the portable terminal, which includes, for example, a smart phone, a cell phone, a notebook PC, and a tablet PC, which can be carried and has a touch screen, and a plurality of applications that can be displayed on the touch screen of the portable terminal. The portable terminal and the applications are controlled by a touch or a hovering event of an input unit such as a finger, an electronic pen, and a stylus pen (hereinafter, the finger, the electronic pen, and the stylus pen are generally referred to as an input unit).

User needs for remote control of the portable terminal are increasing, and the ability to remotely control the portable terminal is required.

### SUMMARY OF THE INVENTION

Accordingly, the present invention is designed to address at least the problems and/or disadvantages described above and to provide at least the advantages described below. Accordingly, aspects of the present invention provide a portable terminal and a method for controlling a touch screen, and a system thereof, wherein the portable terminal can be remotely controlled, an application developer can conduct a test for the portable terminal based on an input unit and perform installation, addition, and deletion of an application as the application developer controls a plurality of portable terminals, and various types of services can be provided to simulate a characteristic function of a terminal having difficulty in using a function such as a sound input and a illumination sensor.

In accordance with an aspect of the present invention, a method for controlling a touch screen of a portable terminal using a remote control is provided. The method includes receiving information regarding at least one event; analyzing a type of the event based on the received information; and displaying a result corresponding to the event on the touch screen by mapping the type of event to a physical input value.

In accordance with another aspect of the present invention, a method for remotely controlling a portable terminal is provided. The method includes executing an application; sensing at least one event input to a screen; analyzing a type of the sensed event using the application, generating information regarding the analyzed event; and transmitting the generated information to the portable terminal.

In accordance with another aspect of the present invention, a portable terminal for remotely controlling a touch screen is provided. The portable terminal includes a transmitter/receiver configured to transmit/receive information regarding at least one event; and a controller configured to analyze a type of the event using the received information, and to map the analyzed type of event to a physical input value to display a result corresponding to the event on the touch screen.

In accordance with another aspect of the present invention, a system for remotely controlling a touch screen of a portable terminal is provided. The system includes a terminal configured to execute an application for sensing an event, to sense at least one event input to a screen, and to generate and transmit information regarding the event; and the portable terminal configured to receive the generated information to analyze a type of the event, and to map the analyzed type of event to a physical input value to display a result corresponding to the event on the touch screen.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram illustrating a portable terminal according to an embodiment of the present invention;

FIG. 2 is a front perspective view illustrating a portable terminal according to an embodiment of the present invention;

FIG. 3 is a rear perspective view illustrating a portable terminal according to an embodiment of the present invention;

FIG. 4 illustrates an input unit and an internal structure of a touch screen according to an embodiment of the present invention;

FIG. 5 illustrates an input unit for providing a hovering input effect according to an embodiment of the present invention;

FIG. 6 illustrates an example of a system for remotely controlling a touch screen of a portable terminal according to an embodiment of the present invention;

FIG. 7 is a flowchart illustrating a method for remotely controlling a touch screen of a portable terminal according to an embodiment of the present invention;

FIG. 8 is a block diagram illustrating a terminal for remotely controlling displaying of a touch screen of a portable terminal according to an embodiment of the present invention;

FIG. 9A is a flowchart illustrating a process in which a terminal remotely controls displaying of a touch screen of a portable terminal according to an embodiment of the present invention;

FIG. 9B is a flowchart illustrating a process of controlling a touch screen of a portable terminal through remote control according to an embodiment of the present invention;

FIGS. 10A and 10B illustrate an example in which a portable terminal is remotely controlled through an event input to a terminal according to an embodiment of the present invention; and

FIGS. 11A and 11B illustrate an example in which a terminal and a portable terminal display an identical result by an event input to the terminal according to an embodiment of the present invention.

### DETAILED DESCRIPTION OF EMBODIMENTS OF THE PRESENT INVENTION

Various embodiments will now be described more fully with reference to the accompanying drawings. It should be understood that there is no intent to limit embodiments to the particular forms disclosed, but on the contrary, the embodiments disclosed herein cover all modifications, equivalents, and alternatives falling within the scope of the invention.

While terms including ordinal numbers, such as “first” and “second,” etc., may be used to describe various components, such components are not limited by the above terms. The terms are used merely for the purpose to distinguish one element from other elements. For example, a first element could be termed a second element, and similarly, a second element could be also termed a first element without departing from the scope of the present invention. As used herein, the term “and/or” includes any and all combinations of one or more of the associated listed items.

The terms used in this application are for the purpose of describing particular embodiments only and are not intended to be limiting of the invention. As used herein, the singular forms are intended to include the plural forms as well, unless the context clearly indicates otherwise. Terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Unless defined otherwise, all terms used herein have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the present invention. It will be further understood that terms, such as those defined in commonly used dictionaries, should be interpreted as having a meaning that is consistent with their meaning in the context of the relevant art and will not be interpreted in an idealized or overly formal sense unless expressly defined herein.

Hereinafter, an operation principle of embodiments of the present invention will be described in detail with reference to the accompanying drawings. In the following description of the present invention, a detailed description of known functions and configurations incorporated herein will be omitted when it may obscure the subject matter of the present invention. The terms which will be described below are terms defined in consideration of the functions of the present invention, and may be different according to users, intentions of the users, or customs. Therefore, its definition will be made based on the overall contents of this specification.

First, terms to be used in the present invention will be defined as follows:

A portable terminal includes a mobile terminal, which can be carried and through which data transmission/reception and voice and video calls can be made, and may include at least one touch screen. The portable terminal may include, for example, a smart phone, a tablet PC, a 3D TV, a smart TV, an LED TV, and an LCD TV, and may include all terminals that can communicate with peripheral devices or other remote terminals.

An input unit includes at least one of a finger, an electronic pen, a pen, a joystick, and a stylus pen, which may provide a command or an input to the portable terminal in a contact state or a non-contact state such as a hovering event on a touch screen.

An object is displayed or may be displayed on the touch screen of the portable terminal. The object includes, for example, at least one of a document, a widget, a photograph, a map, a moving image, an e-mail, a Short Messaging Service (SMS) 10 message, and a Multimedia Messaging Service (MMS) message, and may be executed, deleted, cancelled, stored, and modified by the input unit. The object may also include a shortcut icon, a thumbnail image, and a folder which stores at least one object in the portable terminal.

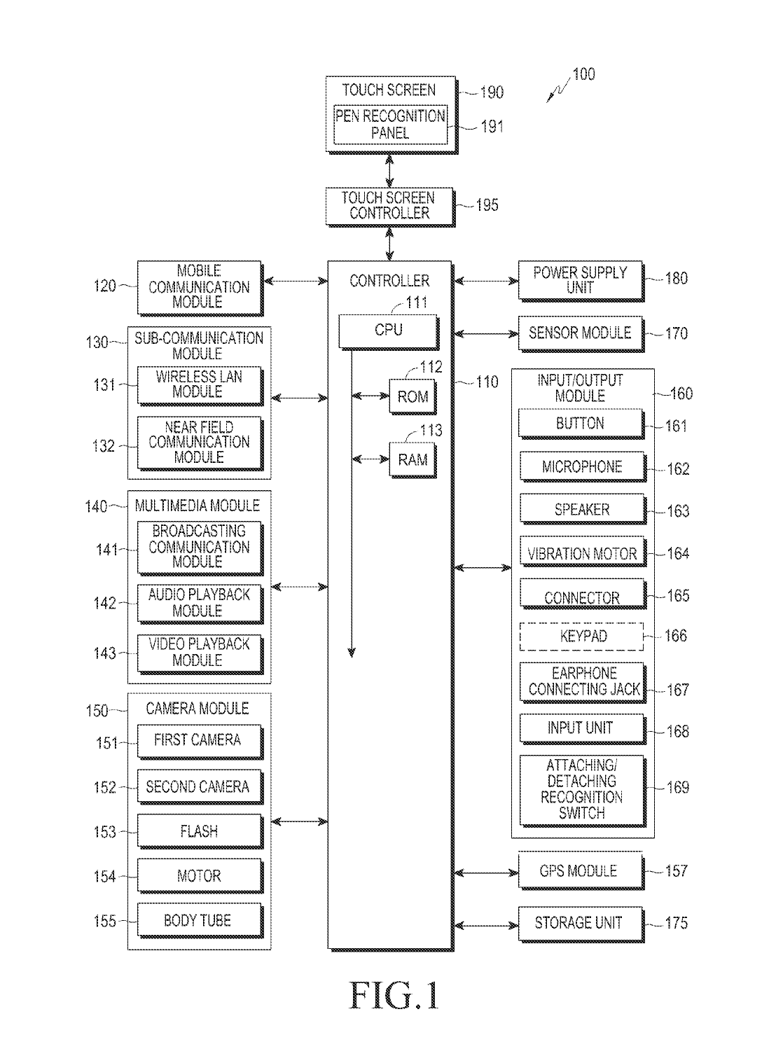

FIG. 1 is a block diagram illustrating a portable terminal according to an embodiment of the present invention.

Referring to FIG. 1, a portable terminal 100 may be connected with an external device (not illustrated) by using at least one of a mobile communication module 120, a sub-communication module 130, a connector 165, and an earphone connecting jack 167. The external device may include various devices, such as, for example, earphones, an external speaker, a Universal Serial Bus (USB) memory, a charger, a Cradle/Dock, a Digital Media Broadcasting (DMB) antenna, a mobile payment related device, a health care device (e.g., a blood sugar measuring device), a game machine, and a vehicle navigation device, which may be detachably connected to the portable terminal 100 in a wired manner. Further, the external device may include a Bluetooth communication device, a Near Field Communication (NFC) device and a Wi-Fi Direct communication device, which may be wirelessly connected to the portable terminal 100, and a wireless Access Point (AP). The portable terminal may be connected to other devices including a cell phone, a smart phone, a tablet PC, a desktop PC, and a server using a wired or wireless manner.

Referring to FIG. 1, the portable terminal 100 includes at least one touch screen 190, and at least one touch screen controller 195. Further, the portable terminal 100 includes a controller 110, the mobile communication module 120, the sub-communication module 130, a multimedia module 140, a camera module 150, a GPS module 157, an input/output module 160, a sensor module 170, a storage unit 175, and a power supply unit 180.

The sub-communication module 130 includes at least one of a wireless LAN module 131 and a Near Field Communication (NFC) module 132. The multimedia module 140 includes at least one of a broadcasting communication module 141, an audio playback module 142, and a video playback module 143. The camera module 150 includes at least one of a first camera 151 and a second camera 152. Further, the camera module 150 of the portable terminal 100 according to the embodiment of the present invention may include at least one of a body tube 155 for a zooming in/out of the first and second cameras 151 and 152, a motor 154 that controls a movement of the body tube 155, and a flash 153 that provides a light source for photography. The input/output module 160 includes at least one of a button 161, a microphone 162, a speaker 163, a vibration motor 164, the connector 165, and a keypad 166.

The controller 110 may include a Central Processing Unit (CPU) 111, a Read Only Memory (ROM) 112, in which a control program for controlling of the portable terminal 100 is stored, and a Random Access Memory (RAM) 113 that stores a signal or data input from the outside of the portable terminal 100, or is used as a memory area for operations performed in the portable terminal 100. The CPU 111 may include a single core, a dual core, a triple core, or a quad core processor. The CPU 111, the ROM 112, and the RAM 113 may be connected with each other through an internal bus.

The controller 110 may control the mobile communication module 120, the sub-communication module 130, the multimedia module 140, the camera module 150, the GPS module 157, the input/output module 160, the sensor module 170, the storage unit 175, the power supply unit 180, the touch screen 190, and the touch screen controller 195.

The controller 110 determines whether or not a hovering event is recognized when an input unit 168 such as, for example, an electronic pen is brought in proximity to any one of objects, and identifies an object corresponding to a location where the hovering event occurs, in a state in which a plurality of objects are displayed on the touch screen 190. The controller 110 may detect a height from the portable terminal 100 to the input unit 168 and a hovering input event according to the height, in which the hovering input event includes at least one of a press of a button formed in the input unit 168, a tap on the input unit 168, a movement of the input unit 168 at a speed higher than a predetermined speed, and a touch on an object displayed on the touch screen 190. The controller 110 displays a predetermined hovering input effect, corresponding to the hovering input event, on the touch screen 190 when the hovering input event is detected.

When receiving information regarding at least one event, the controller 110 analyzes an event type based on the received information, maps the analyzed type of event to a physical input value, and displays a result corresponding to the event on the touch screen 190. The controller 110 transmits the displayed result to the terminal in which the event has occurred. The event type is classified by an input method, through which the event is input to the touch screen of the terminal transmitting information, and includes at least one of a touch, a pressure caused by the touch, a hovering event, a drag, and a gesture. The event is analyzed based on at least one of an input time, a duration time, and input coordinates of at least one of the touch, the pressure caused by the touch, the hovering event, the drag, and the gesture. The mapping results in at least one of the touch, the pressure caused by the touch, the hovering event, the drag, and the gesture, which have been input through the screen of the terminal, being identically applied to the touch screen 190. The information includes information regarding at least one of the input time, the duration time, and the input coordinates of at least one of the touch, the pressure caused by the touch, the hovering event, the drag, and the gesture, which have been input through the screen of the terminal transmitting the information.

The mobile communication module 120 enables the portable terminal 100 to be connected with the external device through mobile communication by using at least one antenna or a plurality of antennas (not illustrated) under the control of the controller 110. The mobile communication module 120 transmits/receives a wireless signal for a voice call, a video call, an SMS, or an MMS to/from a cell phone (not illustrated), a smart phone (not illustrated), a tablet PC, or other devices (not illustrated), which has corresponding contact information input to the portable terminal 100.

The sub-communication module 130 includes at least one of the wireless LAN module 131 and the NFC module 132. For example, the sub-communication module 130 may include only the wireless LAN module 131, or only the NFC module 132. Alternatively, the sub-communication module 130 may include both the wireless LAN module 131 and the NFC module 132. The sub-communication module 130 transmits/receives a control signal to/from the input unit 168.

The wireless LAN module 131 connects to the Internet at a place, where a wireless Access Point (AP) (not illustrated) is installed, under the control of the controller 110. The wireless LAN module 131 supports a wireless LAN protocol (IEEE802.11x) of the Institute of Electrical and Electronics Engineers (IEEE). The NFC module 132 may perform near field communication in a wireless manner between the portable terminal 100 and an image forming device (not illustrated) under the control of the controller 110. The near field communication method may include Bluetooth, Infrared Data Association (IrDA), Wi-Fi direct communication, and Near Field Communication (NFC).

The controller 110 communicates with a neighboring communication device or a remote communication device and communicates with the input unit through at least one of the wireless LAN module 131 and the NFC module 132. Such communication as described above may be made by using transmission/reception of a control signal.

The portable terminal 100 includes at least one of the mobile communication module 120, the wireless LAN module 131, and the NFC module 132 or combinations thereof according to performance requirements of the portable terminal 100. In the present invention, a transmitter/receiver refers to at least one or combinations of the mobile communication module 120, the wireless LAN module 131, and NFC module 132, and does not limit the scope of the present invention.

The multimedia module 140 includes the broadcasting communication module 141, the audio playback module 142, or the video playback module 143. The broadcasting communication module 141 receives a broadcasting signal (for example, a TV broadcasting signal, a radio broadcasting signal, or a data broadcasting signal) and broadcasting additional information (for example, Electric Program Guide (EPS), or Electric Service Guide (ESG)), which are transmitted from a broadcasting station through a broadcasting communication antenna (not illustrated), under the control of the controller 110. The audio playback module 142 may play digital audio files (for example, files with an extension such as mp3, wma, ogg, and way) which are stored or received under the control of the controller 110. The video playback module 143 plays digital video files (for example, files with an extension such as mpeg, mpg, mp4, avi, mov, and mkv) which are stored or received under the control of the controller 110. The video playback module 143 may also play the digital audio files.

The multimedia module 140 may include the audio playback module 142 and the video playback module 143, but not the broadcasting communication module 141. Further, the audio playback module 142 or the video playback module 143 of the multimedia module 140 may be included in the controller 110.

The camera module 150 includes at least one of the first camera 151 and the second camera 152 which photograph a still image and a moving image under the control of the controller 110. Further, the camera module 150 may include at least one of the body tube 155 which performs zoom in/out for the sake of photographing a subject, the motor 154 which controls a movement of the body tube 155, and the flash 153 which provides a subsidiary light source necessary for photographing the subject. The first camera 151 may be disposed on a front surface of the portable terminal 100, and the second camera 152 may be disposed on a rear surface of the portable terminal 100. Alternatively, the first camera 151 and the second camera 152 may be disposed adjacent to each other (for example, an interval between the first camera 151 and the second camera 152 is larger than a distance of 1 cm and smaller than a distance of 8 cm), and may photograph a three dimensional still image or a three dimensional moving image.

Each of the first and second cameras 151 and 152 include a lens system and an image sensor. The first and second cameras 151 and 152 convert an optical signal, which is input (or photographed) through the lens system, into an electric image signal, and output the electric image signal to the controller 110. A user may photograph a moving image or a still image using the first and second cameras 151 and 152.

The input/output module 160 may include at least one of a plurality of buttons 161, the microphone 162, the speaker 163, the vibration motor 164, the connector 165, the keypad 166, the earphone connecting jack 167, and the input unit 168. The input/output module is not limited thereto, and cursor control such as a mouse, a track ball, a joystick, or cursor direction keys may be provided for the sake of communication with the controller 110, and control of a cursor movement on the touch screen 190.

The microphone 162 receives voices or sounds to generate electric signals under the control of the controller 110.

The speaker 163 outputs sounds corresponding to various signals (for example, a wireless signal, a broadcasting signal, a digital audio file, a digital video file, or photography) of the mobile communication module 120, the sub-communication module 130, the multimedia module 140, or the camera module 150 to the outside of the portable terminal 100 under the control of the controller 110. Further, the speaker 163 may output a sound corresponding to a control signal that is transferred to the input unit 168 through the near field communication module 132. The sound corresponding to the control signal includes a sound in response to activation of a vibration element 520 of the input unit 168, a sound whose magnitude is varied depending on a vibration intensity, and a sound in response to deactivation of the vibration element 520. The speaker 163 may output sounds (for example, a button operation tone corresponding to a telephone call, or a call connection tone) corresponding to functions that the portable terminal 100 performs. One or more speakers 163 may be formed at a predetermined location or locations of the housing of the portable terminal 100.

The vibration motor 164 converts an electric signal into a mechanical vibration under the control of the controller 110. For example, the vibration motor 164 operates when the portable terminal 100 in a vibration mode receives a voice call from another device (not illustrated). One or a plurality of vibration motors 164 may be disposed in the housing of the portable terminal 100. The vibration motor 164 may operate in response to a user's touch on the touch screen 190 and a continuous movement of a touch on the touch screen 190.

The input unit 168 may be inserted into and kept in the portable terminal 100 and may be extracted or detached from the portable terminal 100 when being used. An attaching/detaching recognition switch 169 that serves to detect mounting and detaching of the input unit 168 may be installed at an area in the portable terminal 100 into which the input unit 168 is inserted, and may provide a signal corresponding to the mounting and the detaching of the input unit 168 to the controller 110. The attaching/detaching recognition switch 169 is installed at the area in the portable terminal 100 into which the input unit 168 is inserted, and directly or indirectly contacts the input unit 168 when the input unit 168 is mounted. Accordingly, the attaching/detaching recognition switch 169 generates and provides the signal corresponding to the mounting or the detaching of the input unit 168 to the controller 110 based on the direct or indirect contact with the input unit 168.

The sensor module 170 includes at least one sensor that detects a state of the portable terminal 100. For example, the sensor module 170 may include a proximity sensor that detects a user's proximity to the portable terminal 100, an illumination sensor (not illustrated) that detects a quantity of light around the portable terminal 100, a motion sensor (not illustrated) that detects a motion (for example, rotation of the portable terminal 100 and acceleration or a vibration applied to the portable terminal 100) of the portable terminal 100, a geo-magnetic sensor which detects a point of a compass by using Earth's magnetic field, a gravity sensor which detects an action direction of gravity, and an altimeter that detects an altitude by measuring atmospheric pressure. At least one sensor may detect a state, and generate and transmit a signal corresponding to the detected state to the controller 110. A sensor of the sensor module 170 may be added or excluded according to performance requirements of the portable terminal 100.

The storage unit 175 may store a signal or data, which is input and output to correspond to operations of the mobile communication module 120, the sub-communication module 130, the multimedia module 140, the camera module 150, the GPS module 157, the input/output module 160, the sensor module 170, and the touch screen 190, under the control of the controller 110. The storage unit 175 may store control programs for control of the portable terminal 100 or the controller 110, or applications.

The term “storage unit” refers to the storage unit 175, the ROM 112 and the RAM 113 in the controller 110, or a memory card (not illustrated) (for example, an SD card and a memory stick) that is mounted to the portable terminal 100. The storage unit may include a non-volatile memory, a volatile memory, a Hard Disk Drive (HDD), or a Solid State Drive (SSD).

The storage unit 175 may store applications with various functions such as a navigation, a video call, a game and a time based alarm application, images for the sake of providing a Graphic User Interface (GUI) related to the applications, user information, a document, databases or data related to a method of processing a touch input, background images (a menu screen and a standby screen) or operating programs necessary for driving the portable terminal 100, and images photographed by the camera module 150. The storage unit 175 is a machine (for example, a computer) readable medium, which is a term that may be defined as a medium that provides data to the machine so that the machine may perform a specific function. The machine readable medium may be a storage medium. The storage unit 175 may include a non-volatile memory and a volatile memory. All such mediums should be tangible such that commands transferred through the mediums may be detected by a physical mechanism that reads the commands into the machine.

The machine readable medium is not limited thereto, and includes at least one of a floppy disk, a flexible disk, a hard disk, a magnetic tape, a Compact Disc Read-Only Memory (CD-ROM), an optical disk, a punch card, a paper tape, a RAM, a Programmable Read-Only Memory (PROM), an Erasable PROM (EPROM), and a FLASH-EPROM.

The portable terminal 100 may include one or more touch screens that provide user interfaces corresponding to various services (for example, a telephone call, data transmission, broadcasting, and photography) to the user. Each of the touch screens may transmit an analog signal corresponding to at least one touch input to the user interface, to the corresponding touch screen controller 195. In this scenario, the portable terminal 100 may include a plurality of touch screens, and each of the touch screens may include a touch screen controller receiving an analog signal corresponding to a touch. The touch screens may be connected to a plurality of housings connected by a hinge, respectively, or the plurality of the touch screens may be located in a single housing without a hinge connection. As described above, the portable terminal 100 according to the present invention may include at least one touch screen, and for convenience of description, one touch screen will be described hereinafter.

The touch screen 190 may receive at least one touch through a user's body (for example, fingers including a thumb) or a touchable input unit (for example, a stylus pen or an electronic pen). Further, when a touch is input through the stylus pen or the electronic pen, a pen recognition panel 191 recognizes the touch input detects a distance between the pen and the touch screen 190 through a magnetic field. Furthermore, the touch screen 190 may receive a continuous movement of the at least one touch. The touch screen 190 transmits an analog signal corresponding to the continuous movement of the input touch to the touch screen controller 195.

In the present invention, the touch is not limited to the contact between the touch screen 190 and the user's body or the touchable input unit, and may include non-contact (for example, a space (for example, about 5 mm) by which the touch can be detected without contact between the touch screen 190 and the user's body or the touchable input unit). The detectable space in the touch screen 190 may be varied according to a performance or a structure of the portable terminal 100. The touch screen 190 is configured such that values (for example, including an analog value such as a voltage value or a current value) detected by a touch event and a hovering event may be output differently from each other, in order to differentially detect the touch event through contact with the user's body or the touchable input unit and the input event (for example, a hovering event) in a non-contact state. Preferably, the touch screen 190 differently outputs the detected values (for example, current values) according to a distance between the space where the hovering event occurs and the touch screen 190.

For example, the touch screen 190 may utilize a resistive method, a capacitive method, an infrared method, or an acoustic wave method.

The touch screen 190 may include at least two touch screen panels that can detect touches or a proximity of a user's body and a touchable input unit, respectively, such that inputs through the user's body the touchable input unit may be sequentially or simultaneously received. The at least two touch screen panels may provide mutually different output values to the touch screen controller, and the touch screen controller may differently recognize the values input from the at least two touch screen panels and may identify which of the inputs (the user's body or the touchable input unit) the input from the touch screen 190 corresponds to. The touch screen 190 displays one or more objects.

More specifically, the touch screen 190 may be formed with a structure in which a panel that detects an input through a finger or the input unit 168 by using a change in an induced electromotive force and a panel that detects contact on the touch screen through a finger or the input unit 168 are attached to each other, or are spaced slightly apart from each other and stacked on one another. The touch screen 190 includes a plurality of pixels, and displays an image through the pixels. The touch screen 190 may include, for example, a Liquid Crystal Display (LCD), an Organic Light Emitting Diode (OLED), or a Light Emitting Diode (LED).

The touch screen 190 includes a plurality of sensors that detects a location of a finger or the input unit 168 when the finger or the input unit 168 contacts a surface of the touch screen 190 or is spaced apart from the touch screen by a predetermined distance. The plurality of sensors may be formed with a coil structure, and in a sensor layer formed of the plurality of sensors, the sensors are arranged in a predetermined pattern and form a plurality of electrode lines. In the structure as described above, a detection signal, whose waveform is changed, is generated due to an electrostatic capacity between the sensor layer and the input unit when contact or a hovering input occurs through the finger or the input unit 168 on the touch screen 190, and the touch screen 190 transmits the generated detection signal to the controller 110. A distance between the input unit 168 and the touch screen 190 may be detected using an intensity of a magnetic field generated by a coil 510 disposed in the input unit 168.

The touch screen receives an input of at least one event. A type of the event is classified by an input method through which the event is input to the touch screen of the terminal transmitting information, and includes at least one of a touch, a pressure caused by the touch, a hovering event, a drag, and a gesture. The event is analyzed through at least one of an input time, a duration time, and input coordinates of at least one of the touch, the pressure caused by the touch, the hovering event, the drag, and the gesture.

Meanwhile, the touch screen controller 195 converts the analog signal received from the touch screen 190 to a digital signal (for example, X and Y coordinates), and then transmits the digital signal to the controller 110. The controller 110 controls the touch screen 190 using the digital signal received from the touch screen controller 195. For example, the controller 110 may allow a shortcut icon (not illustrated) or an object displayed on the touch screen 190 to be selected, or may execute the shortcut icon or the object in response to a touch event or a hovering event. Further, the touch screen controller 195 may also be included in the controller 110.

The touch screen controller 195 may detect a value (for example, a current value) output through the touch screen 190 to determine a distance between a space where a hovering event occurs and the touch screen 190, and convert the determined distance value into a digital signal (for example, Z-coordinate) to provide the digital signal to the controller 110.

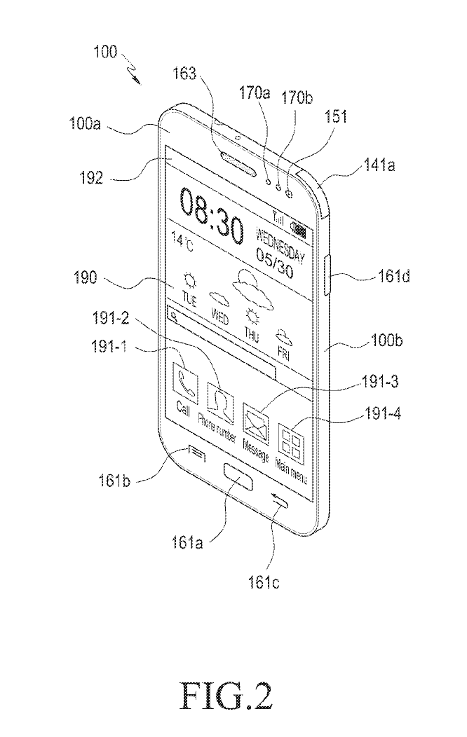

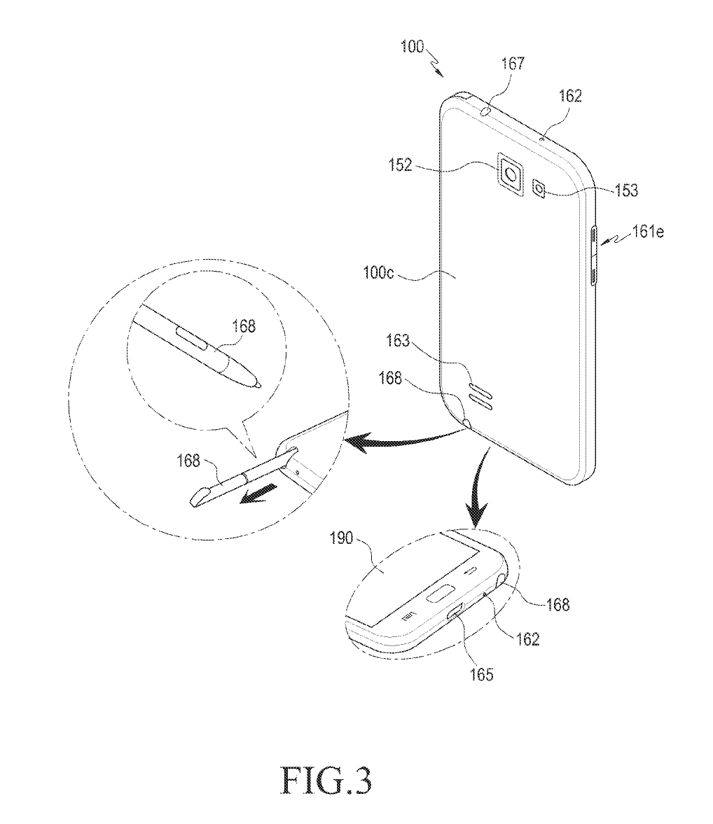

FIG. 2 is a front perspective view illustrating a portable terminal according to an embodiment of the present invention, and FIG. 3 is a rear perspective view illustrating a portable terminal according to an embodiment of the present invention.

Referring to FIGS. 2 and 3, a touch screen 190 is disposed at a central area of a front surface 100a of a portable terminal 100. The touch screen 190 may be largely formed to occupy most of the front surface 100a of the portable terminal 100. FIG. 2 illustrates an embodiment in which a main home screen is displayed on the touch screen 190. The main home screen corresponds to a first screen displayed on the touch screen 190, when a power source of the portable terminal 100 is turned on. Further, the main home screen may correspond to a first home screen among the several pages of home screens in a case where the portable terminal 100 has several pages of different home screens. Shortcut icons 191-1, 191-2, and 191-3 for executing frequently used applications, a main menu key 191-4, a time, and weather may be displayed in the home screen. A menu screen is displayed on the touch screen 190 through the main menu key 191-4. Furthermore, a status bar 192 that displays a status of the portable terminal 100 such as a battery charging status, an intensity of a received signal, and a current time may also be formed at an upper end portion of the touch screen 190.

A home button 161a, a menu button 161b, and a back button 161c may be formed below the touch screen 190.

The main home screen is displayed on the touch screen 190 using the home button 161a. For example, in a state where the menu screen or another home screen different from the main home screen is being displayed on the touch screen 190, when the home button 161a is touched, the main home screen may be displayed on the touch screen 190. Moreover, the main home screen illustrated in FIG. 2 may be displayed on the touch screen 190 when the home button 161a is touched while applications are executed on the touch screen 190. Furthermore, the home button 161a may also be used to display recently used applications or a task manager on the touch screen 190.

The menu button 161b provides a connection menu that may be used on the touch screen 190. The connection menu may include, for example, a widget addition menu, a background image change menu, a search menu, an edition menu, and an environment setup menu.

The back button 161c may be used to display a screen that was executed shortly before a currently executed screen, or terminate the most recently used application.

A first camera 151, an illumination sensor 170a, and a proximity sensor 170b may be disposed on an upper side of the front surface 100a of the portable terminal 100. A second camera 152, a flash 153, and a speaker 163 may be disposed on a rear surface 100c of the portable terminal 100.

For example, a power/reset button 161d, a volume button 161e, a terrestrial DMB antenna 141a for reception of broadcasting, and one or a plurality of microphones 162 may be disposed on a side surface 100b of the portable terminal 100. The DMB antenna 141a may be fixed to the portable terminal 100, or may be formed detachably from the portable terminal 100.

A connector 165 is formed on a lower side surface of the portable terminal 100. A plurality of electrodes are formed in the connector 165, and may be wire connected with the external device. An earphone jack 167 may be formed on an upper side surface of the portable terminal 100. Earphones may be inserted into the earphone jack 167.

An input unit 168 may be provided on the lower side surface of the portable terminal 100. The input unit 168 may be inserted into and kept in the portable terminal 100, and may be extracted and detached from the portable terminal 100 for use.

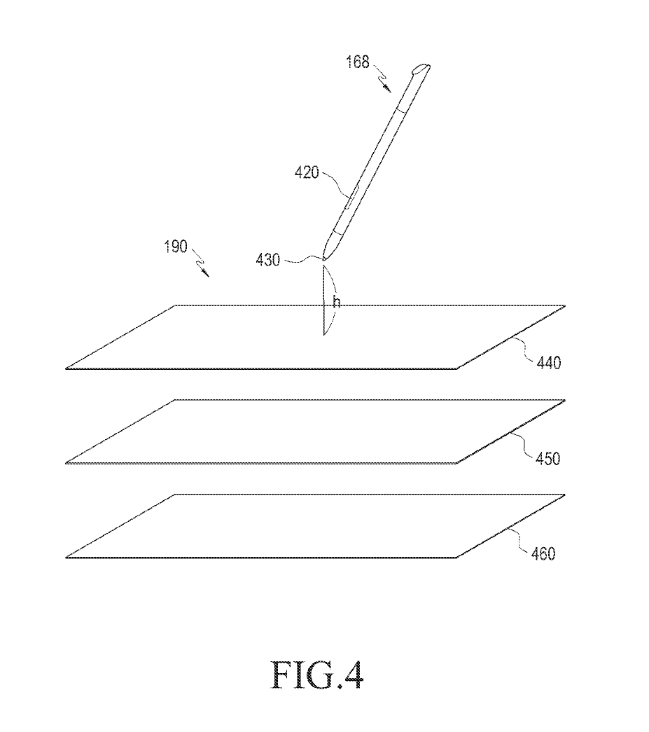

FIG. 4 is a perspective view illustrating the input unit 168 and an internal structure of the touch screen 190 according to an embodiment of the present invention.

Referring to FIG. 4, the touch screen 190 includes a first touch panel 440, a display panel 450, and a second touch panel 460. The display panel 450 may be a panel such as an LCD panel or an AMOLED panel, and display various operation states of a portable terminal 100, various images according to application execution and a service, and a plurality of objects.

The first touch panel 440 corresponds to a capacitive type touch panel, in which a thin metal conductive substance (for example, an Indium Tin Oxide (ITO) film) is coated on opposite surfaces of a glass substrate so that a current flows on the surfaces of the glass substrate, and then a dielectric substance, which can store an electric charge, is coated. When an input unit (for example, a user's finger or a pen) touches a surface of the first touch panel 440, a predetermined amount of electric charge moves to a touched location by static electricity, and the first touch panel 440 recognizes a variation in the current according to a movement of the electric charge to detect the touched location. All touches that may cause static electricity, and a touch by a finger or a pen, can be detected through the first touch panel 440.

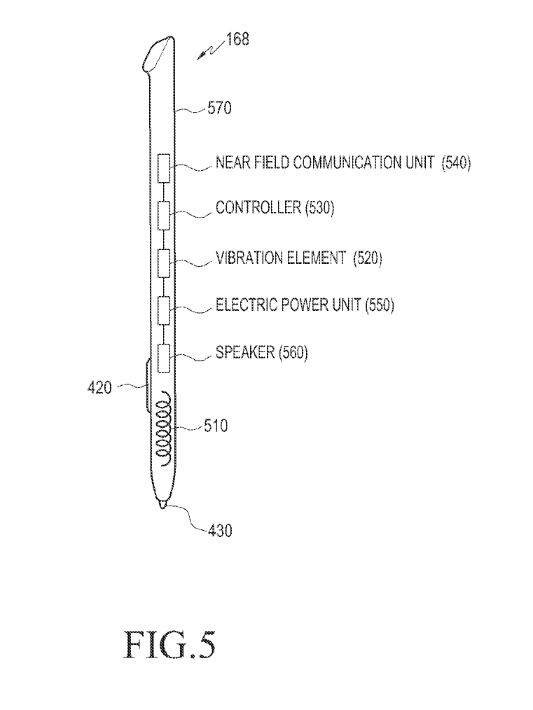

The second touch panel 460 corresponds to an Electro Magnetic Resonance (EMR) type touch panel, and includes an electromagnetic induction coil sensor (not illustrated) that has a grid structure in which a plurality of loop coils are arranged in a predetermined first direction and in a second direction intersecting with the first direction, and an electromagnetic signal processing unit (not illustrated) that sequentially provides an alternating current signal having a predetermined frequency to the loop coils of the electromagnetic induction coil sensor. When an input unit 168 including a resonance circuit therein is brought in proximity of the loop coils of the second touch panel 460, a magnetic field that is transmitted from the corresponding loop coil causes a current based on mutual electromagnetic induction in the resonance circuit in an interior of the input unit 168. An induction magnetic field is generated based on the current from a coil (not illustrated) that makes up the resonance circuit in the interior of the input unit 168. The second touch panel 460 detects the induction magnetic field around the loop coil in a signal reception state to sense a hovering location or a touch location of the input unit 168, and the portable terminal 100 senses a height (h) from the first touch panel 440 to a pen point 430 of the input unit 168. It will be readily understood by those skilled in the art to which the present invention pertains that the height (h) from the first touch panel 440 of the touch screen 190 to the pen point 430 may be varied to correspond to a performance or a structure of the portable terminal 100. If an input unit causes a current based on electromagnetic induction, a hovering event and a touch can be detected through the second touch panel 460. The second touch panel 460 is used for detection of the hovering event or the touch by the input unit 168. The input unit 168 may be referred to as an electromagnetic pen or an EMR pen. Further, the input unit 168 may be different from a general pen that does not include the resonance circuit detected through the first touch panel 440. The input unit 168 may be configured to include a button 420 that may vary an electromagnetic induction value generated by a coil that is disposed adjacent to the pen point 430 in an interior of the input unit 168. The input unit 168 will be more specifically described below with reference to FIG. 5.

A touch screen controller 195 may include a first touch panel controller and a second touch panel controller. The first touch panel controller converts an analogue signal received from the first touch panel 440, through detection of a hand touch or a pen touch, into a digital signal (for example, X, Y, and Z coordinates), and transmits the digital signal to the controller 110. The second touch panel controller converts an analogue signal received from the second touch panel 460, through detection of a hovering event or a touch of the input unit 168, into a digital signal, and transmits the digital signal to the controller 110. The controller 110 controls the display panel 450, the first touch panel 440, and the second touch panel 460 by using the digital signals received from the first and second touch panel controllers. For example, the controller 110 may display a screen in a predetermined form on the display panel 450 in response to the hovering event or the touch of the finger, the pen, or the input unit 168.

Accordingly, the first touch panel 440 may sense the touch by the user's finger or the pen, and the second touch panel may sense the hovering event or the touch by the input unit 168 in the portable terminal 100 according to the embodiment of the present invention. The controller 110 of the portable terminal 100 may differentially sense the touch by the user's finger or the pen, and the hovering event or the touch by the input unit 168. Although only one touch screen is illustrated in FIG. 4, the present invention is not limited thereto and a plurality of touch screens may be provided. The plurality of touch screens may be disposed in housings, respectively, and may be connected with each other by hinges, or the plurality of touch screens may be disposed in a single housing. The plurality of touch screens are configured to include a display panel and at least one touch panel, as illustrated in FIG. 4.

FIG. 5 illustrates an input unit for providing a hovering input effect according to an embodiment of the present invention.

Referring to FIG. 5, the input unit 168 (for example, a touch pen) according to the embodiment of the present invention includes a pen body 570; a pen point 430 disposed at an end of the pen body 570; a button 420 that may vary an electromagnetic induction value generated by the coil 510 that is disposed adjacent to the pen point 430 in an interior of the pen body 570; a vibration element 520 that vibrates when the hovering input effect is generated; a controller 530 that analyzes a control signal received from a portable terminal 100 through a hovering event of the input unit 168 hovering over the portable terminal 100, and controls an intensity and a period of a vibration of the vibration element 520 in order to provide a haptic effect to the input unit 168; a near field communication unit 540 that performs near field communication with the portable terminal 100; and an electric power unit 550 that supplies electric power for vibration of the input unit 168. Further, the input unit 168 may include a speaker 560 that outputs a sound corresponding to the intensity and the period of the vibration of the input unit 168. The speaker 560 may output a sound corresponding to the haptic effect provided to the input unit 168, at the same time as or at a predetermined time interval (for example, 10 ms) before or after the speaker 163 installed in the portable terminal 100.

The input unit 168 having such a configuration as described above supports an electrostatic induction method. A touch screen 190 is configured to recognize a touch point by detecting a location of a magnetic field, when the magnetic field is formed by the coil 510 at a predetermined point of the touch screen 190.

More specifically, the speaker 560 may output sounds corresponding to various signals (for example, a wireless signal, a broadcasting signal, a digital audio file, and a digital video file) that are received from a mobile communication module 120, a sub-communication module 130, and a multimedia module 140, which are installed in the portable terminal 100, under the control of the controller 530. Further, the speaker 560 may output sounds (for example, a button operation tone corresponding to a telephone call, or a call connection tone) corresponding to functions that the portable terminal 100 performs. One or more speakers 560 may be installed at a predetermined location or locations of the pen body 570.

The controller 530 analyzes at least one control signal that is received from the portable terminal 100 through the near field communication unit 540, and controls a vibration intensity and a vibration period of the vibration element 520 according to the analyzed control signal, when the pen point 430 contacts the touch screen 190 or is situated at a location (for example, 5 mm above the touch screen) where a hovering event is sensed. The controller 530 may charge the electric power unit 550 according to the received control signal, and transmit a feedback signal corresponding to the received control signal to the portable terminal 100. The control signal corresponds to a signal transmitted to/received from the portable terminal 100 and the input unit 168, and may be periodically transmitted/received for a predetermined period of time or until the hovering event is completed.

Further, the control signal is transmitted to the input unit 168 by at least one of the mobile communication module 120 and the sub-communication module 130 of the portable terminal 100. The control signal includes at least one of information for activating a mode of the vibration element of the input unit 168, information representing the vibration intensity of the input unit 168, information for deactivating the mode of the vibration element of the input unit 168, and information representing a total time interval during which the haptic effect is provided. Since the control signal has a size of about 8 bits, and is repeatedly transmitted to the input unit 168 at predetermined time intervals (for example, every 5 ms) to control a vibration of the input unit 168, a user can recognize that a vibration according to the haptic effect is repeatedly performed according to a predetermined period. The vibration strengths of the actuator have strengths corresponding to 0 to 255. Each vibration strength value of the 125, 131 and 0 indicates a vibration strength of the actuator 520. Also, each of the vibration strengths (e.g., 125, 125, 131, 131 and 0) is repeatedly outputted at every predetermined interval (e.g., every 5 ms). For example, a control signal that controls a vibration may include information as illustrated in Table 1 below.

TABLE 1

| | Vibration | | Vibration |
|---|---|---|---|
| | element | Vibration | element |
| Field | Activation | Intensity | Deactivation |
| Information | 1 | 125 125 131 131 0 | 2 |

As illustrated in Table 1, the control signal includes information for activating the vibration element 520 of the input unit, information representing the vibration intensity of the vibration element 520, and information for deactivating the vibration element 520. Although the control signal may be transmitted to the input unit 168 in 5 ms periods, this is only illustrative, and transmission of the control signal may be varied according to a period of a haptic pattern. Further, a transmission period of the control signal, the vibration intensity, and a transmission time interval may all be varied as well.

The input unit 168 having such a configuration as described above supports an electrostatic induction method. The touch screen 190 is configured to recognize the touch point by detecting the location of the corresponding magnetic field, when the magnetic field is formed by the coil 510 at the predetermined point of the touch screen 190.

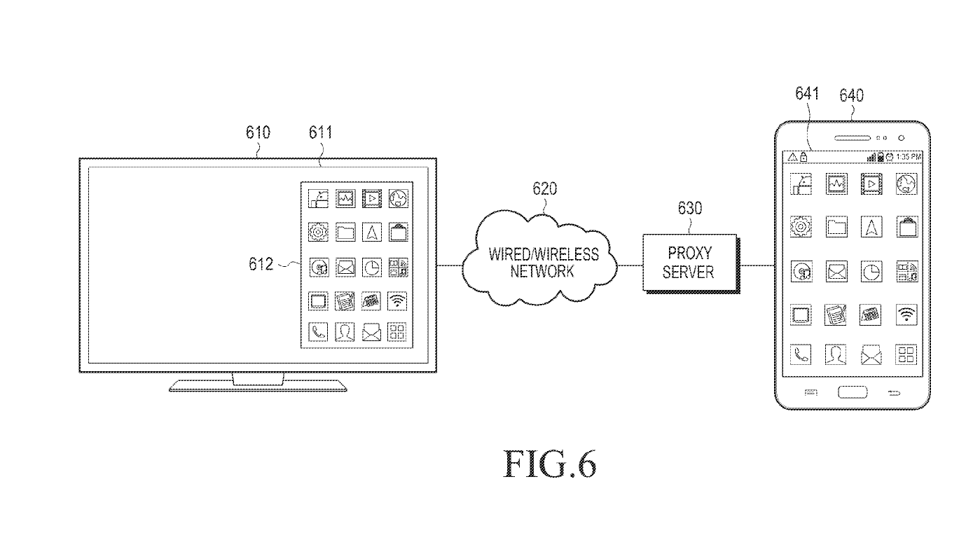

FIG. 6 illustrates an example of a system for remotely controlling a touch screen of a portable terminal according to an embodiment of the present invention.

Referring to FIG. 6, the system according to the embodiment of the present invention, which remotely controls the touch screen of the portable terminal, includes a terminal 610 that senses an event of a screen; a wired/wireless network 620 that transmits information received from the terminal to a proxy server 630; the proxy server 630 that is wire/wirelessly connected to the wired/wireless network and transmits the information to the portable terminal 640; and the portable terminal 640 that displays a result of the sensed event and transmits the displayed result back to the terminal 610. The terminal 610 may include all or some (for example, a controller, a storage unit, a touch screen, a sub-communication module, and the like) of the elements of the portable terminal 640 which are illustrated in FIG. 1.

The terminal 610 and the portable terminal 640 may include mobile terminals which can be carried and through which data transmission/reception and voice and video calls can be made, and may include one or more touch screens. The terminal 610 and the portable terminal 640 may include, for example, a smart phone, a tablet PC, a 3D TV, a smart TV, an LED TV, an LCD TV, and the like, and may communicate with peripheral devices or other remote terminals.

The wired/wireless network 620 and the proxy server 630 may be omitted if, for example, the terminal 610 and the portable terminal 640 are located proximate to each other, or can communicate with each other on a one to one basis. The proxy server 630 may receive the event sensed on the screen of the terminal 610 to analyze an event type, and map the analyzed type of event to a physical input value to transmit the mapped input value to the portable terminal 640. At least one of the terminal 610 and the portable terminal 640 may perform the functions which are performed in the proxy server.

Hereinafter, the system according to the embodiment of the present invention, which remotely controls the touch screen of the portable terminal, will be described more specifically with reference to FIG. 6.

The terminal 610 senses at least one event that is input to the screen 611, by executing an application that senses an event through an input unit. The terminal 610 generates information on the sensed event and transmits the information to the portable terminal 640. The application senses an event type corresponding to at least one of a pressure caused by a touch, a hovering event, a drag, and a gesture, which are input to the screen 611 of the terminal 610. The application analyzes at least one of an input time, a duration time, and input coordinates, corresponding to the sensed event. The application maps the sensed event through the analyzed result such that the sensed event may be identically executed in the portable terminal 640. The screen 611 may display a screen 612 of at least one portable terminal 640, and may control a touch screen 641 of at least one portable terminal 640. The application may control the portable terminal 640 through synchronization with the portable terminal 640 situated at a remote location. The screen 611 of the terminal 610 may display the same screen 612 as the touch screen 641 of the portable terminal 640 through the application. In this state, the application senses an event that is input to the screen 612, and generates information regarding the sensed event. The terminal 610 transmits the generated information to the portable terminal 640 through at least one of the wire/wireless network 620 and the proxy server 630. Alternatively, the information may be directly transmitted to the portable terminal 640 without the wired/wireless network 620 and the proxy server 630. The information includes at least one of an input time, a duration time, and input coordinates corresponding to the event. Further, the information may include a type of input event.

The proxy server 630 transmits the information regarding the event, which is input to the screen 611 of the terminal 610, to the portable terminal 640, and transmits data, which the portable terminal 640 generates, back to the terminal 610. The proxy server 630 may or may not be necessary for this functionality according to the embodiment of the present invention, which remotely controls the touch screen 641 of the portable terminal 640.

The portable terminal 640 analyzes the event type, maps the analyzed event to a physical input value, and displays a result corresponding to the event on the touch screen 641, when the terminal 610 does not analyze the event type and has a function for the analyzed event.

More specifically, the portable terminal 640 may be controlled by the terminal 610. When information regarding at least one event is received from the terminal 610, the portable terminal 640 analyzes a type of event by using the received information, maps the analyzed type of event to a physical input value, and displays a result corresponding to the event on the touch screen 641. The mapping implies that the result of the sensed event is made to identically occur on the touch screen 641 of the portable terminal 640 as well as if the event was made directly to the touch screen 641.

As described above, the terminal 610 may control the portable terminal 640, and the terminal 610 and the portable terminal 640 may display identical screens through the system according to the embodiment of the present invention, which remotely controls the touch screen 641 of the portable terminal 640.

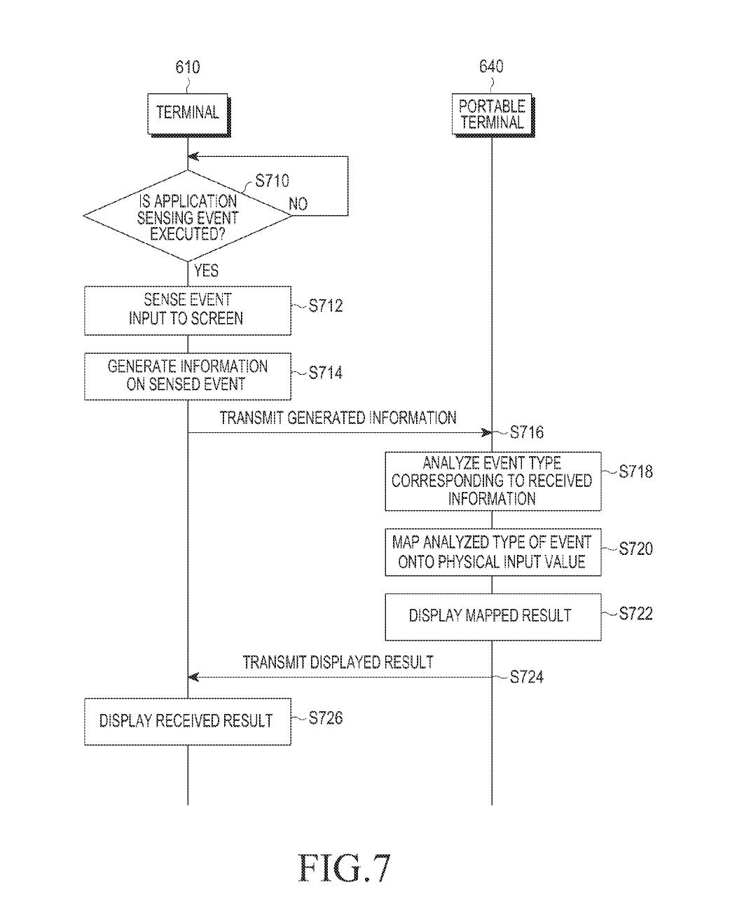

FIG. 7 is a flowchart illustrating a method for remotely controlling a touch screen of a portable terminal according to an embodiment of the present invention.

In step S710, a terminal 610 determines whether an application that senses an event input to the a screen of the terminal 610 is executed. If it is determined that the application is executed, the terminal 610 proceeds to step S 712 and senses an event that is input to the screen. The event includes at least one of a touch on the screen, a pressure caused by the touch, a hovering event, a drag, and a gesture, and is analyzed through at least one of an input time, a duration time, and input coordinates. If, in step S710, it is determined that the application is not executed, the terminal repeats step S710 and continues to determine whether the application is executed.

In step S714, information regarding the sensed event is generated when. The information includes at least one of the input time, the duration time, and the input coordinates of at least one of the touch on the screen of the terminal 610, the pressure caused by the touch, the hovering event, the drag, and the gesture. Further, the information may further include at least one of a sound, an intensity of illumination, a temperature, humidity, and an inclination, which are measured in the terminal 610.

In step S716, the information generated in step S714 is transmitted to a proxy server or the portable terminal 640 through a wired/wireless network.

In step S718, the portable terminal 640 analyzes an event type corresponding to the received information. The event type includes at least one of the touch input to the screen of the terminal 610, the pressure caused by the touch, the hovering event, the drag, and the gesture. The portable terminal 640 determines at least one of the input time, the duration time, and the input coordinates of the event, by analyzing the received information.

In step S720, the analyzed type of event is mapped to a physical input value. The physical input value refers to an input value by which the input physically sensed on the screen of the terminal 610 is converted to be identically applied to the portable terminal 640. The mapping causes the result of the sensed event to identically occur on the touch screen of the portable terminal 640, or, alternatively, causes the result of the event input to the touch screen to identically occur on a screen of the portable terminal 640 having no touch function. That is, the portable terminal 640 may be remotely controlled due to the mapping of the type of event to the physical input value.

In step S722, the mapped result of step S720 is displayed on the touch screen of the portable terminal 640. In step S724, the displayed result and a command required for the displaying are transmitted to the terminal 610. The transmitted command identically provides the result displayed on the touch screen of the portable terminal 640 through the screen having no touch function as well.

In step S726, the terminal 610 maps and displays the received command again. The displaying in the terminal 610 and the portable terminal 640 may be performed either simultaneously or with a temporal difference.

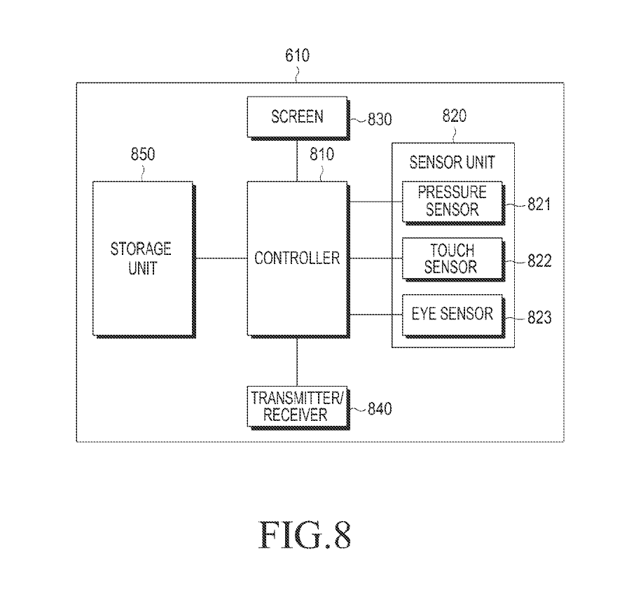

FIG. 8 is a block diagram illustrating a terminal 610 for remotely controlling displaying of a touch screen of a portable terminal according to an embodiment of the present invention.

Referring to FIG. 8, the terminal 610 includes a controller 810; a sensor unit 820; a screen 830 that displays data to a user; a transmitter/receiver 840 that transmits/receives data to/from an external device such as a portable terminal or a server; and a storage unit 850 that stores the transmitted/received data or an application that senses an event on the screen 830.

The sensor unit 820 is configured with at least one module sensing at least one event. The sensor unit 820 includes a pressure sensor 821 that senses a pressure by a touch input to the screen 830, a touch sensor 822 that senses a touch input to the screen 830, and an eye sensor 823 including at least one camera (not shown) that senses an input by a movement of an eye of a person and a size of a pupil. Further, the sensor unit 820 may also include a module that senses a variety of inputs in addition to an input unit or a user's bio-information.

The screen 830 displays data to a user, and extracts a pressure intensity of a generated touch and coordinates of a touched point to transmit the pressure intensity and the coordinates to the controller 810, when a touch by an input unit or a user's finger is detected. The screen 830 displays an application that senses an event input to the screen 830. The application senses at least one event input to the screen, analyzes a type of sensed event, and generates information regarding the analyzed event. The screen 830 receives and displays the result displayed on the portable terminal in correspondence to the sensed event. The event may be classified by an input method through which the event is input to the screen, and includes at least one of a touch on the screen, a pressure caused by the touch, a hovering event, a drag, and a gesture. The storage unit 850 stores not only various programs and applications required to configure the terminal 610, but also an application that senses various events input to the screen 830. The transmitter/receiver 840 may transmit/receive data to/from the portable terminal or other devices, and transmits information, which is generated by the application sensing the event, to the portable terminal.

The controller 810 executes the application stored in the storage unit 850 to sense an event input to the screen 830, and/or controls the screen 830 to sense at least one event input to the screen 830. The controller 810 analyzes a type of the sensed event, generates information regarding the analyzed event, and transmits the information to the portable terminal. The generated information may be classified by an event, and includes at least one of an input time, a duration time, and an input coordinates of the event. The controller 810 detects a pressure through a surface area where a finger contacts the screen 830. In this case, the screen 830 provides visual indication by the touch to a user under the control of the controller 810. For example, the controller 810 may provide a larger ripple as a pressure by a finger or an input unit increases, and a smaller ripple as the pressure decreases. The controller 810 may display the ripple on the screen 830 for a predetermined period of time, when the touch is completed. Further, the controller 810 analyzes a type of input event, maps the analyzed type of event to a physical input value, and displays a result corresponding to the event on the touch screen. The mapping is to identically display at least one of the touch input to the screen 830, the pressure caused by the touch, the hovering event, the drag, and the gesture on the touch screen of the portable terminal.

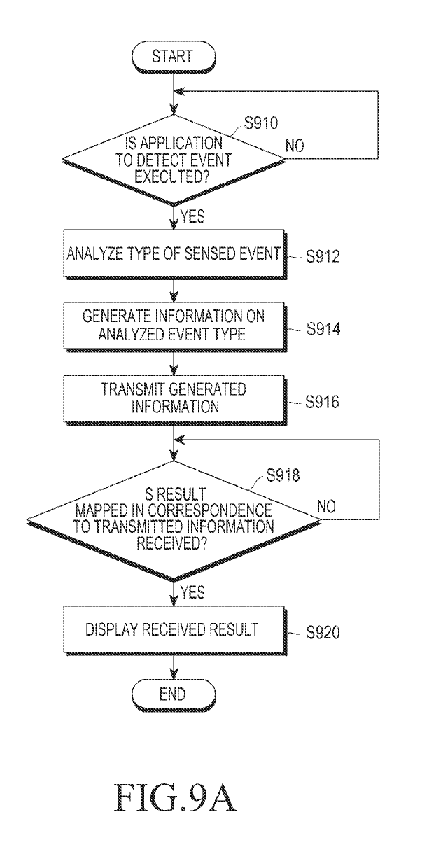

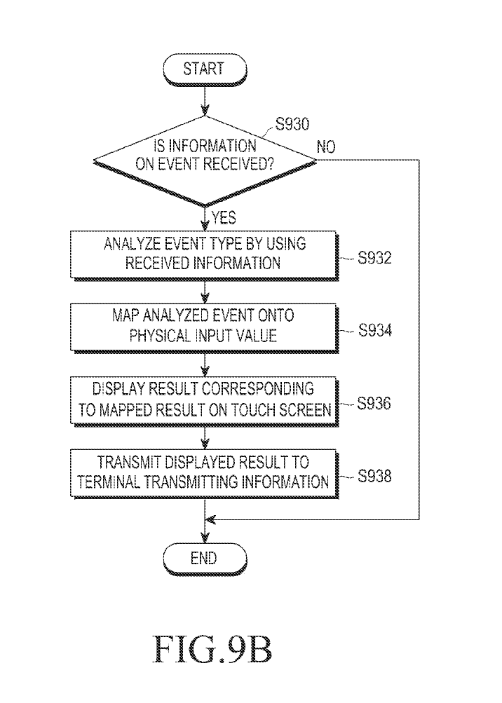

FIG. 9A is a flowchart illustrating a process in which a terminal according to an embodiment of the present invention remotely controls displaying of a touch screen of a portable terminal.

In step S910, it is determined whether an application for sensing an input event is executed. The event may be classified by an input method through which the event is input to a screen, and includes at least one of a touch on the screen, a pressure caused by the touch, a hovering event, a drag, and a gesture. The event may include various commands, which control the portable terminal or the touch screen of the portable terminal, in addition to those described above.

When it is determined that the application is executed, the method proceeds to step S912 and a type of a sensed event is analyzed. In step S914, information regarding the analyzed event type is generated. The information includes at least one of an existence of a touch on the screen, a pressure caused by the touch, a touched point, a touch time, a touch direction, existence of a hovering event, a hovering direction, a hovering point, a hovering time, a drag, a drag direction, a drag point, a drag time, a gesture, a gesture direction, a gesture time, and a gesture point.

In step S914, the information generated in step S914 is transmitted to the portable terminal. The information may be directly transmitted to the portable terminal, or may be transmitted to the portable terminal through a wired/wireless network or a proxy server.

In step S918, it is determined if a result that is mapped to correspond to the transmitted information transmitted from the portable terminal is received. If the result is received, the method proceeds to step S920 and displays the received result. If the result is not received, the method repeats step S918 and continues to determine if the result is received. When the portable terminal receives the information, the portable terminal analyzes an event type, maps the analyzed type of event onto a physical input value, and displays the result corresponding to the event on the touch screen. The portable terminal transmits the displayed result or a command required to display the result to the terminal, and the terminal displays the identical result, which is displayed in the portable terminal, on the screen by receiving the displayed result or the command.

FIG. 9B is a flowchart illustrating a process of controlling a touch screen of a portable terminal through remote control according to an embodiment of the present invention.

In step S930, it is determined whether information on an event is received. If the information is received, the method proceeds to step S932, in which an event type is analyzed using the received information. The information includes information regarding at least one of an input time, a duration time, and input coordinates of at least one of a touch input to a screen of a terminal transmitting the information, a pressure caused by the touch, a hovering event, a drag, and a gesture. Further, the information may further include at least one of a sound, an intensity of illumination, a temperature, humidity, and an inclination, which are measured in the terminal transmitting the information.

The event type is classified by an input method through which the event is input to the touch screen of the terminal transmitting the information, and includes at least one of a touch, a pressure caused by the touch, a hovering event, a drag, and a gesture. The event is analyzed through at least one of an input time, a duration time, and input coordinates of at least one of the touch, the pressure by the touch, the hovering event, the drag, and the gesture.

In step S934, the analyzed event is mapped to a physical input value. In step S936, a result corresponding to the mapped result is displayed on the touch screen. The physical input value refers to an input value, to which the input physically sensed on the screen of the terminal is converted to be identically applied to the portable terminal 640. The mapping is to identically display at least one of the touch input to the screen of the terminal, the pressure caused by the touch, the hovering event, the drag, and the gesture on the touch screen.

In step S938, the result displayed in the step S936 is transmitted to the terminal transmitting the information. The portable terminal displays the mapped result on the touch screen, and transmits the result displayed on the touch screen or a command required to display the result to the terminal. The command is to identically provide the result displayed on the touch screen of the portable terminal through the screen having no touch function as well.

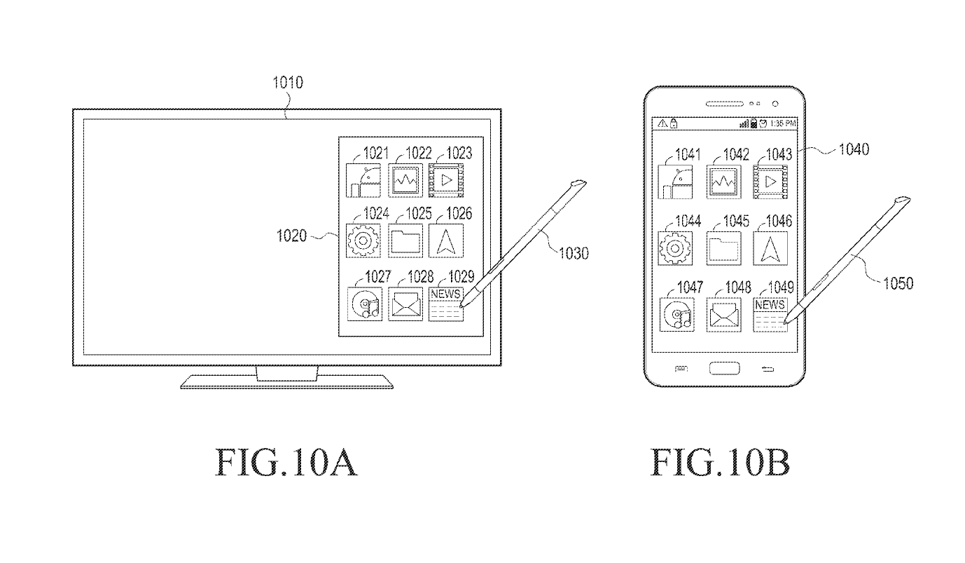

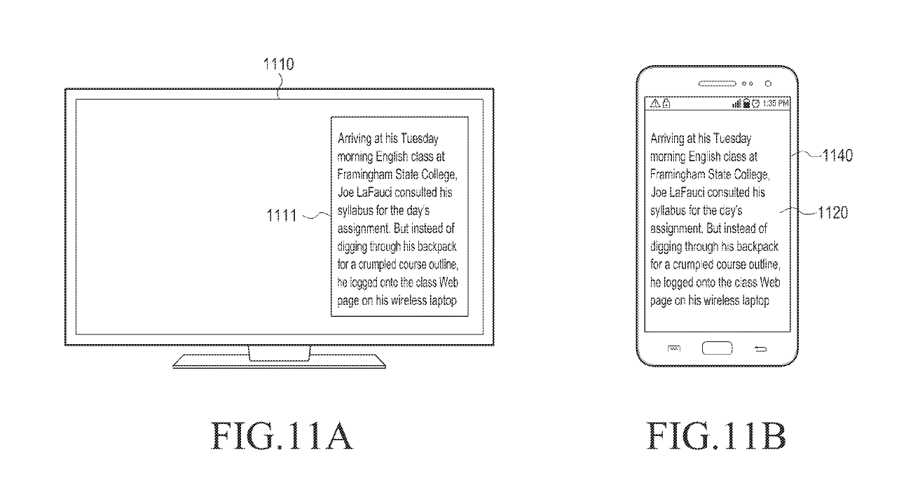

FIG. 10 illustrates a scenario in which a portable terminal is remotely controlled through an event input to a terminal according to an embodiment of the present invention, and FIG. 11 illustrates a scenario in which a terminal and a portable terminal display an identical result by an event input to the terminal according to an embodiment of the present invention.

A screen 1010 of the terminal displays the same result as that displayed on a touch screen 1040 of at least one portable terminal. That is, a screen 1020 displayed on the screen 1010 of the terminal is identical to a screen displayed on the touch screen 1040 of the portable terminal. A plurality of icons or objects 1021 to 1029 are displayed on the screen 1020, and correspond to a plurality of icons or objects 1041 to 1049, respectively, displayed on the touch screen 1040 of the portable terminal. When an event including at least one of a touch, a hovering event, a drag, and a gesture is input to the screen 1010 of the terminal using an input unit 1030 or a finger (not illustrated), an application installed in the terminal senses the input event, analyzes a type of event, and maps the analyzed type of event to a physical input value.

As shown in FIG. 10, when an input (namely, execution) for a newspaper icon 1029 is made by the input unit 1030 on the screen 1020 displayed on the screen 1010 of the terminal, this causes the same result as an input for a newspaper icon 1049 made by an input unit 1050 in the portable terminal.

That is, referring to FIG. 11, a newspaper article 1111 displayed on the screen 1110 of the terminal is identical to a newspaper article 1120 displayed on the touch screen 1140 of the portable terminal.

Although a method, in which the portable terminal having a touch function is controlled through the screen having no touch function, has been described in the present invention, this method is only illustrative. Alternatively, in the present invention, the screen of the terminal having no touch function may be controlled through an event input to the touch screen having a touch function. Further, the present invention may be applied between portable terminals including a touch screen having a touch function.

It should be appreciated that the embodiments of the present invention can be implemented in software, hardware, or a combination thereof. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. It will be appreciated that a memory, which may be incorporated in a portable terminal, may be an example of a machine-readable storage medium which is suitable for storing a program or programs including commands to implement the embodiments of the present invention. Therefore, embodiments of the present invention provide a program including codes for implementing a system or method claimed in any claim of the accompanying claims and a machine-readable device for storing such a program. Moreover, such a program as described above can be electronically transferred through an arbitrary medium such as a communication signal transferred through wired or wireless connection, and the present invention properly includes the things equivalent to that.

Moreover, the above-described portable terminal can receive the program from a program provision device which is connected thereto in a wired or wireless manner, and store the program. The program providing apparatus may include a memory for storing a program containing instructions for allowing the portable terminal to perform a preset content protecting method and information required for the content protecting method, a communication unit for performing wired or wireless communication with the portable terminal, and a controller for transmitting the corresponding program to the portable terminal according to a request of the portable terminal or automatically.

Although specific embodiments have been described in the description of the present invention, it will be apparent that various modifications may be carried out without departing from the scope of the present invention. Therefore, the scope of the present invention should not be defined as being limited to the described embodiments, but should instead be defined by the appended claims and equivalents thereof.

What is claimed is:

1. A method for controlling a touch screen of a portable terminal through remote control, the method comprising:
receiving information regarding at least one event;
analyzing a type of the event using the received information; and
displaying a result corresponding to the event on the touch screen by mapping the analyzed type of event to a physical input value.

2. The method of claim 1, further comprising;
transmitting the displayed result to a terminal in which the event has occurred.

3. The method of claim 1, wherein the type of the event is classified by an input method through which the event is input to a screen of a terminal that transmits the information, and comprises at least one of a touch, a pressure caused by the touch, a hovering event, a drag, and a gesture.

4. The method of claim 3, wherein the event is analyzed by at least one of an input time, a duration time, and input coordinates of at least one of the touch, the pressure caused by the touch, the hovering event, the drag, and the gesture.

5. The method of claim 3, wherein the mapping identically applies and displays at least one of the touch input to the screen of the terminal, the pressure caused by the touch, the hovering event, the drag, and the gesture to and on the touch screen.

6. The method of claim 1, wherein the information includes at least one of an input time, a duration time, and input coordinates of at least one of a touch input to a screen of a terminal that transmits the information, a pressure caused by the touch, a hovering event, a drag, and a gesture.

7. The method of claim 1, wherein the information includes at least one of a sound, an intensity of illumination, a temperature, humidity, and an inclination, which are measured in a terminal that transmits the information.

8. A method for remotely controlling a portable terminal, comprising:
executing an application for sensing an event input to a screen;
sensing at least one event input to the screen;
analyzing a type of the sensed event using the executed application;
generating information regarding the analyzed event; and
transmitting the generated information to the portable terminal.

9. The method of claim 8, further comprising:
receiving a result displayed corresponding to the sensed event from the portable terminal; and
displaying the result.

10. The method of claim 8, wherein the event is classified by an input method through which the event is input to the screen, and comprises at least one of a touch on the screen, a pressure caused by the touch, a hovering event, a drag, and a gesture.

11. The method of claim 8, wherein the generated information is classified by the event, and comprises at least one of an input time, a duration time, and input coordinates of the event.

12. The method of claim 8, wherein the application senses the input event to analyze the type of event, and maps the analyzed type of event to a physical input value.

13. A portable terminal for remotely controlling a touch screen, the portable terminal comprising:
a transmitter/receiver configured to transmit/receive information regarding at least one event; and
a controller configured to analyze a type of the event using the received information, and to map the analyzed type of event to a physical input value to display a result corresponding to the event on the touch screen.

14. The portable terminal of claim 13, wherein the transmitter/receiver transmits the displayed result to a terminal in which the event has occurred.

15. The portable terminal of claim 14, wherein the type of the event is classified by an input method through which the event is input to a screen of a terminal that transmits the information, and comprises at least one of a touch, a pressure caused by the touch, a hovering event, a drag, and a gesture.

16. The portable terminal of claim 15, wherein the event is analyzed by at least one of an input time, a duration time, and input coordinates of at least one of the touch, the pressure caused by the touch, the hovering event, the drag, and the gesture.

17. The portable terminal of claim 15, wherein the mapping identically applies and displays at least one of the touch input to the screen of the terminal, the pressure caused by the touch, the hovering event, the drag, and the gesture to and on the touch screen.

18. A system for remotely controlling a touch screen of a portable terminal, the system comprising:
a terminal configured to execute an application that senses an event, to sense at least one event input to a screen, and to generate and transmit information regarding the event; and
the portable terminal configured to receive the generated information to analyze a type of event, and to map the analyzed type of event to a physical input value to display a result corresponding to the event on the touch screen.

19. The system of claim 18, wherein the terminal receives the displayed result from the portable terminal, and displays the displayed result on the screen.

20. The system of claim 18, wherein the mapping causes the result of the sensed event to identically occur on the touch screen of the portable terminal.
